(19) United States
(12) Patent Application Publication
(10) Pub. No.: US 2013/0329903 A1
(43) Pub. Date: Dec. 12, 2013

(54) MULTIFUNCTIONAL BLUETOOTH EARPHONE DEVICE WITH NECK SPEAKERS

(71) Applicant: Shao-Chieh TING, New Taipei City (TW)

(72) Inventor: Shao-Chieh TING, New Taipei City (TW)

(21) Appl. No.: 13/491,041

(22) Filed: Jun. 7, 2012

(51) Int. Cl. H04R 1/10; H04B 7/00

(52) U.S. Cl. 381/74

(57) ABSTRACT

The present invention is constituted by a neck band assembly, a left functional assembly and a right functional assembly. The left functional assembly is provided with a speaker, control keys and a left earplug-type earphone. The right functional assembly is provided with a speaker, control keys and a right earplug-type earphone. When a user is listening music, he or she can hear exterior sound and when the present invention is used in a closed space, it will not interfere with other people. An angle of open and close between the left or right functional assembly and the neck band assembly can be adjusted. The left and right functional assemblies can be rotated, folded and closed. The neck band assembly can be also changed to a hair band assembly.

### BACKGROUND OF THE INVENTION

a) Field of the Invention

The present invention relates to a multifunctional Bluetooth earphone device with neck speakers, and more particularly to a Bluetooth earphone device with neck speakers, wherein the Bluetooth earphone device is provided with speakers and wired earplug-type earphones, with that the speakers and the earplug-type earphones are able to be switched freely depending upon various conditions. In addition, the earplug-type earphone can be fixed on a left and right functional assembly, with that an angle of open and close between the left or right functional assembly and a neck band assembly is able to be adjusted by a user to meet various requirements. Besides, the left and right functional assemblies can be rotated, folded and closed at a same time, thereby reducing a size of the earphone device that the user can contain it easily.

b) Description of the Prior Art

In nowadays, more and more electronic equipment are provided with the Bluetooth function, and a cell phone is the product that uses the Bluetooth technology most, especially that a smart phone has almost taken the Bluetooth as a standard configuration. The application of Bluetooth technology to the cell phone is mainly to accomplish wireless data transmission over a short distance, especially that when dialoguing, the user can release both hands with Bluetooth earphones and his or her brain can be kept away from cell phone radiation.

Most of the Bluetooth earphones sold on existing markets are earplug-type earphones and the users can be easily fatigued when wearing them for a long time. On the other hand, comfortable-type Bluetooth earphones are too big to be used and contained conveniently.

Accordingly, to solve the abovementioned problems, a multifunctional Bluetooth earphone device with neck speakers is invented. This earphone device is able to reduce a size of containment and can be worn for a long time, as well.

### SUMMARY OF THE INVENTION

The primary object of the present invention is to provide a multifunctional Bluetooth earphone device with neck speakers, including primarily a neck band assembly or a hair band assembly, a left functional assembly and a right functional assembly. The left and right functional assemblies as well as the neck band assembly or the hair band assembly are all connected by sheathing pivots with shaft holes.

Another object of the present invention is to provide a multifunctional Bluetooth earphone device with neck speakers, wherein an angle of open and close between the left or right functional assembly and the neck band assembly or the hair band assembly can be adjusted by the user to meet various requirements. In addition, the left and right functional assemblies can be rotated, folded and closed at a same time to reduce the size of earphone device that the user can contain it easily.

Still another object of the present invention is to provide a multifunctional Bluetooth earphone device with neck speakers, wherein the speakers and wired earplug-type earphones provided on the left and right functional assemblies can be switched freely according to various conditions.

Yet still another object of the present invention is to provide a multifunctional Bluetooth earphone device with neck speakers, wherein the wired earplug-type earphones can be contained and fixed on the left and right functional assemblies.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional front view of a multifunctional Bluetooth earphone device with neck speakers, according to the present invention.

FIG. 2 shows a three-dimensional rear view of the multifunctional Bluetooth earphone device with neck speakers, according to the present invention.

FIG. 3 shows a three-dimensional exploded view of the multifunctional Bluetooth earphone device with neck speakers, according to the present invention.

FIG. 4 shows a three-dimensional schematic view of the multifunctional Bluetooth earphone device with neck speakers, according to the present invention, with that the earphone device is closed by rotation.

FIG. 5 shows a plan view of a left and right functional assembly of the multifunctional Bluetooth earphone device with neck speakers, according to the present invention, with that the left and right functional assemblies are closed by rotation.

FIG. 5A shows a local exploded view of the left and right functional assembly of the multifunctional Bluetooth earphone device with neck speakers, according to the present invention, with that the left and right functional assemblies are closed by rotation.

FIG. 6 shows a three-dimensional front view of another embodiment of the multifunctional Bluetooth earphone device with neck speakers, according to the present invention.

FIG. 7 shows a three-dimensional rear view of another embodiment of the multifunctional Bluetooth earphone device with neck speakers, according to the present invention.

FIG. 8 shows a three-dimensional exploded front view of another embodiment of the multifunctional Bluetooth earphone device with neck speakers, according to the present invention.

FIG. 9 shows a three-dimensional exploded rear view of another embodiment of the multifunctional Bluetooth earphone device with neck speakers, according to the present invention.

FIG. 10 shows a three-dimensional schematic view of another embodiment of the multifunctional Bluetooth earphone device with neck speakers, according to the present invention, with that the earphone device is closed by rotation.

### DETAILED DESCRIPTION OF THE PREFERRED EMBODIMENTS

Regarding the detailed description and technical contents of the present invention, the description is given below for a neck-wearing Bluetooth earphone device and a hair band Bluetooth earphone device as embodiments, along with the drawings.

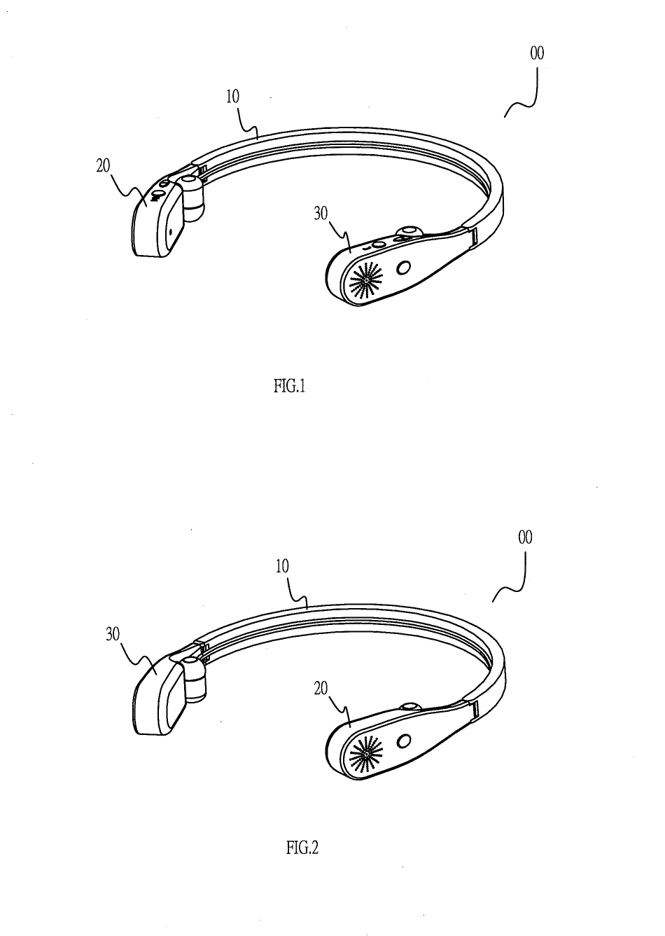

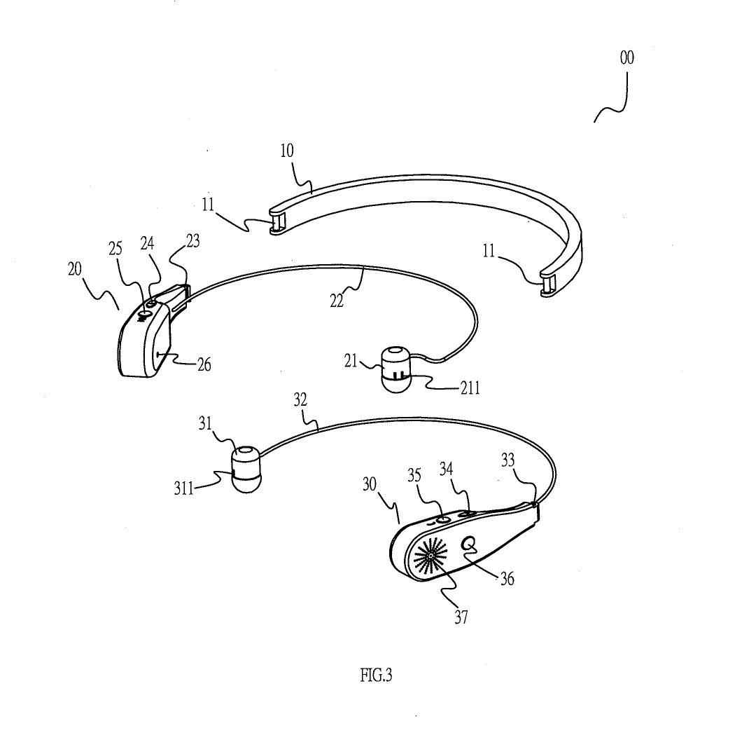

Referring to FIG. 1 and FIG. 2, it shows a three-dimensional front view and a three-dimensional rear view of a multifunctional Bluetooth earphone device with neck speakers. As shown in the drawings, a neck-wearing Bluetooth earphone device 00 comprises a neck band assembly 10, a left functional assembly 20 and a right functional assembly 30.

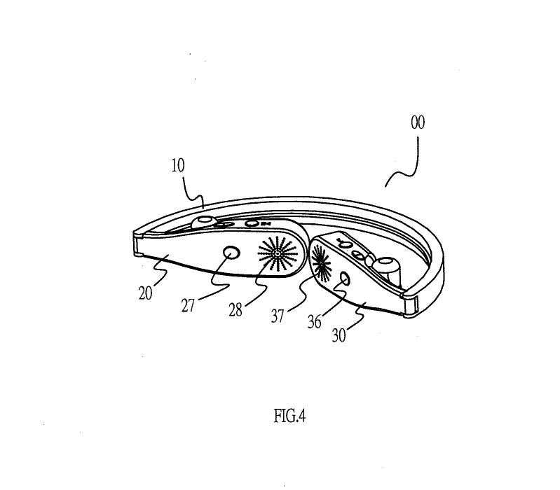

Referring to FIGS. 3 to 5 at a same time, it shows a three-dimensional exploded view and schematic views of the multifunctional Bluetooth earphone device with neck speakers, with that the earphone device is closed by rotation. The neck band assembly 10 is used to connect with the left functional assembly 20 and the right functional assembly 30. Two sides of the neck band assembly 10 are all provided with a neck band pivot 11 to sheath with shaft holes 23, 33 on the left and right functional assemblies 20, 30, achieving an object of opening and closing the left and right functional assemblies 20, 30 by rotation.

The left functional assembly 20 is one core of the Bluetooth earphone device and is provided with a wired left earplug-type earphone 21. The left earplug-type earphone 21 is provided with an earphone fixing slot 211 which can be sheathed and fixed with a tenon 38 on the right functional assembly 30. An earphone connecting wire 22 and the shaft hole 23 are used to sheath with the neck band pivot 11 on the neck band assembly 10. The left functional assembly 20 includes a program selection key 24, a pause key 25, a microphone 26, an earphone-to-speaker switching key 27 and a speaker 28 (not shown in the drawings). The earphone-to-speaker switching key 27 provides for switching among users.

The right functional assembly 30 is another core of the Bluetooth earphone device and is provided with a wired right earplug-type earphone 31. The right earplug-type earphone 31 is provided with an earphone fixing slot 311 which can be sheathed and fixed with a tenon (not shown in the drawings) on the left functional assembly 20. An earphone connecting wire 32 and the shaft hole 33 are used to sheath with the neck band pivot 11 on the neck band assembly 10. The right functional assembly 30 includes a volume adjustment key 34, a receiving key 35, a power switch 36 and a speaker 37.

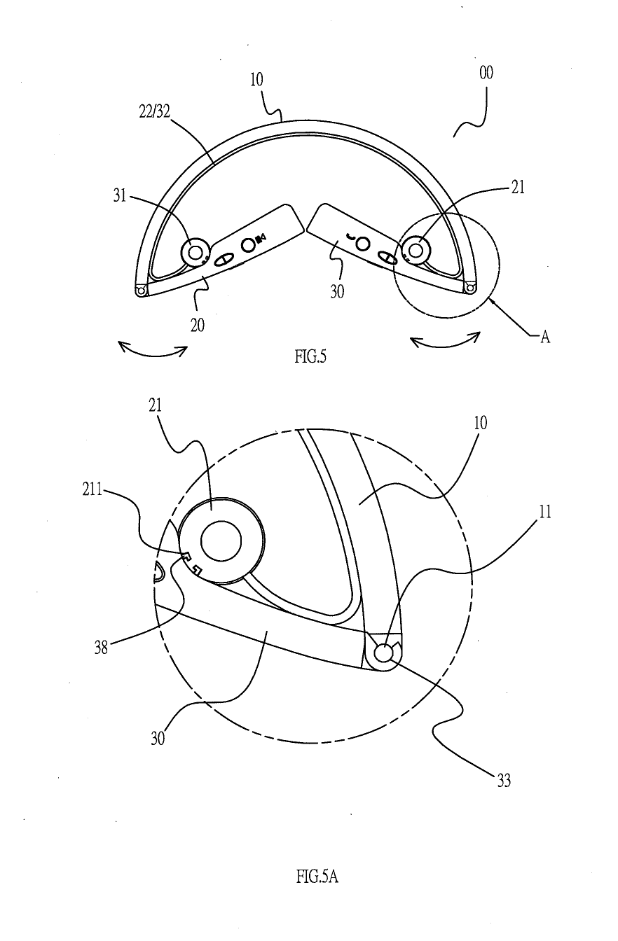

Referring to FIG. 5 and FIG. 5A again, it shows a plan view and a local exploded view of the left and right functional assemblies of the multifunctional Bluetooth earphone device with neck speakers 00, with that the left and right functional assemblies are closed by rotation. The drawings disclose in details the method of sheathing the shaft hole 33 of the right functional assembly 30 with the neck band pivot 11 of the neck band assembly 10. In addition, the earphone fixing slot 211 on the left earplug-type earphone 21 is latched with the tenon 38 on the right functional assembly 30. The method of connecting and fixing the left functional assembly 20 with the neck band assembly 10 and the right earplug-type earphone 31 is also the same as the abovementioned.

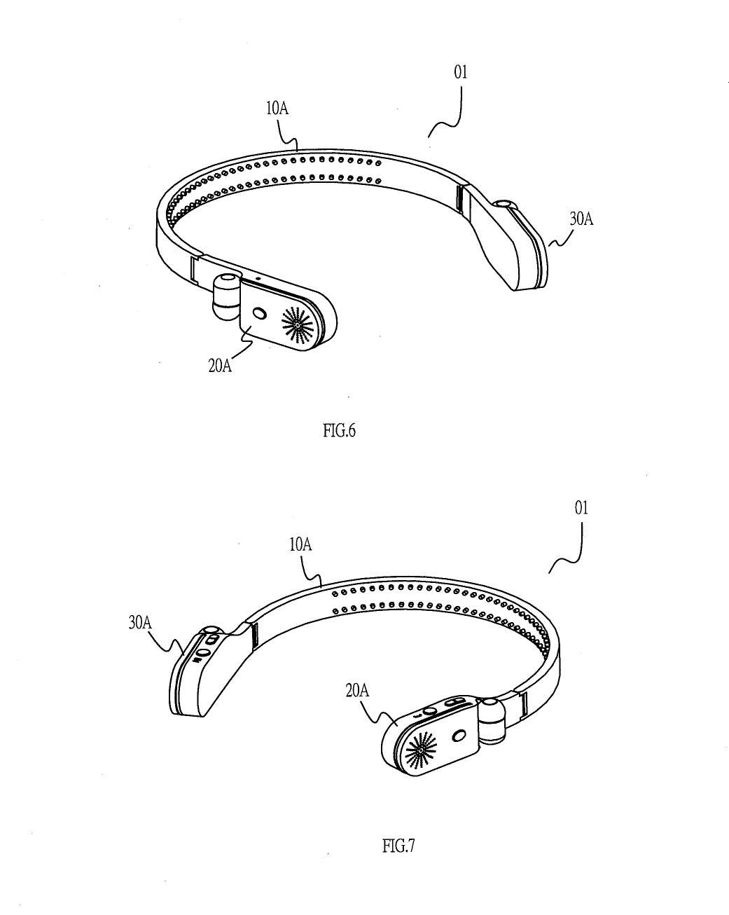

Referring to FIG. 6 and FIG. 7, it shows a three-dimensional front view and a three-dimensional rear view of another embodiment, which is a hair band Bluetooth earphone device 01, of the present invention. As shown in the drawings, the hair band Bluetooth earphone device 01 comprises a hair band assembly 10A, a left functional assembly 20A and a right functional assembly 30A.

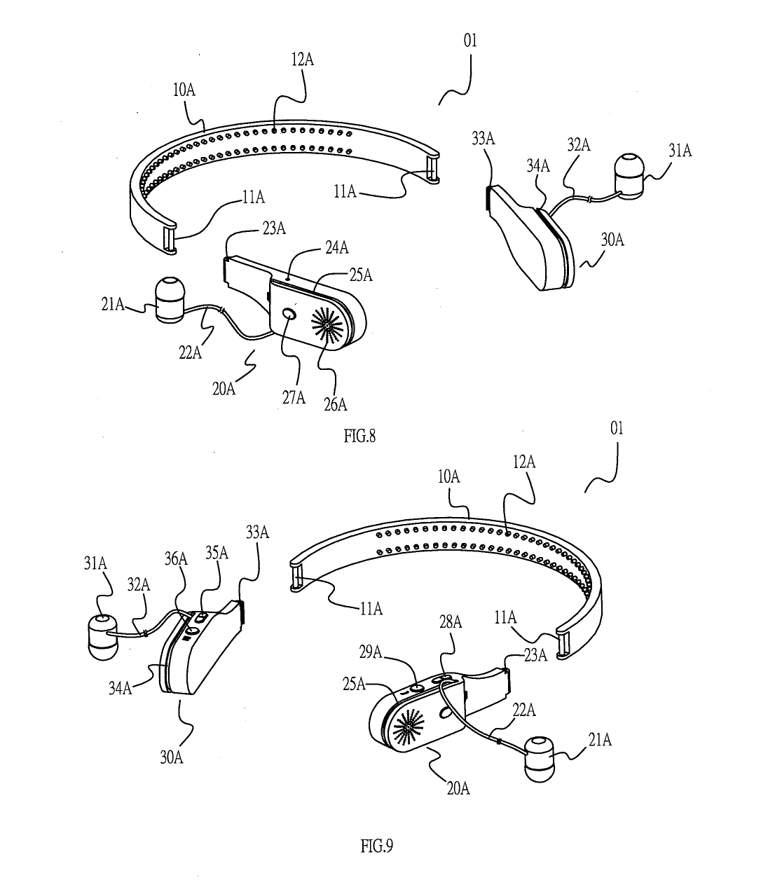

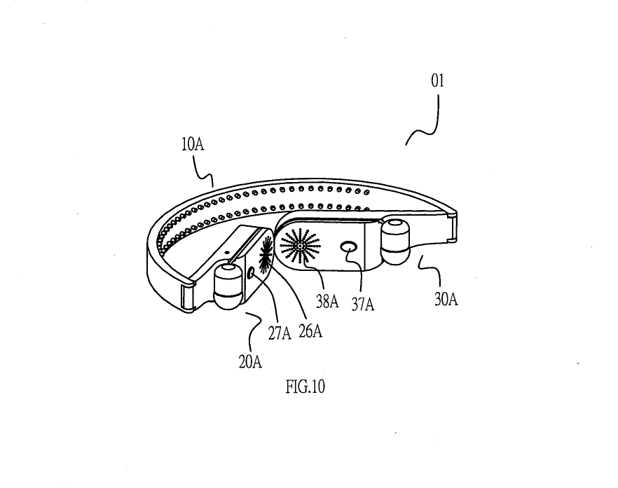

Referring to FIGS. 8 to 10 at a same time, it shows a three-dimensional front view and a three-dimensional rear view of the abovementioned hair band Bluetooth earphone device 01, as well as a three-dimensional schematic view of the hair band Bluetooth earphone device 01 that is closed by rotation. The hair band assembly 10A is used to connect with the left and right functional assemblies 20A, 30A and two sides of the hair band assembly 10A are all provided with a pivot 11A to sheath with shaft holes 23A, 33A on the left and right functional assemblies 20A, 30A, achieving an object of opening and closing the left and right functional assemblies 20A, 30A by rotation. An interior side of the hair band assembly 10A is provided with plural comb pillars 12A, such that the Bluetooth earphone device can be worn stably.

The left functional assembly 20A is one core of the Bluetooth earphone device and is provided with a wired earplug-type earphone 21A, an earphone connecting wire 22A, the shaft hole 23A which is used to sheath with the pivot 11A on the hair band assembly 10A, a microphone 24A, an earphone wire slot 25A, a speaker 26A, a power switch 27A, a volume adjustment key 28A and a receiving key 29A.

The right functional assembly 30A is another core of the Bluetooth earphone device and is provided with a wired earplug-type earphone 31A, an earphone connecting wire 32A, a shaft hole 33A which is used to sheath with the pivot 11A on the hair band assembly 10A, an earphone wire slot 34A; a program selection key 35A, a pause key 36A, an earphone-to-speaker switching key 37A and a speaker 38A.

The method of connecting and fixing the left and right functional assemblies 20A, 30A with the earplug-type earphones 21A, 31A of the hair band Bluetooth earphone device 01 is the same as that of the neck band Bluetooth earphone device 00; therefore, no further description is disclosed.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multifunctional Bluetooth earphone device with neck speakers, comprising:
a neck band assembly or a hair band assembly, the band assembly is used to connect with a left and right functional assembly; wherein the functional assembly is provided with a speaker, a program selection key, a pause key, a microphone, an earphone-to-speaker switching key and a wired left earplug-type earphone that is fixed; and the right functional assembly is provided with a speaker, a volume adjustment key, a receiving key, a power switch and a wired right earplug-type earphone that is fixed.

2. The multifunctional Bluetooth earphone device with neck speakers, according to claim 1, wherein the left and right functional assemblies are opened and closed by rotation.

3. The multifunctional Bluetooth earphone device with neck speakers, according to claim 1, wherein the earphone-to-speaker switching key allows for switching among users.

4. The multifunctional Bluetooth earphone device with neck speakers, according to claim 1, wherein the wired earplug-type earphones are contained and fixed on the left and right functional assemblies.
